(19) United States
(12) Patent Application Publication
(10) Pub. No.: US 2010/0223061 A1
(43) Pub. Date: Sep. 2, 2010

(54) Method and Apparatus for Audio Coding

(75) Inventor: Juha Petteri Ojanpera, Nokia (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/395,599

(22) Filed: Feb. 27, 2009

(51) Int. Cl. G10L 19/02; G10L 21/00; G10L 19/14

(52) U.S. Cl. 704/500; 704/229; 704/205; 704/E19.005; 704/E21.001

(57) ABSTRACT

In accordance with an example embodiment of the present invention, there is provided an apparatus for encoding an audio signal in two or more encoding stages, the audio signal comprising a set of frequency components. The apparatus comprises a frequency component selection unit configured to select a number of frequency components from the set for encoding in a current encoding stage, the selected frequency components being components of the set that have not been encoded to a non-zero value in a preceding encoding stage; and an encoding unit configured to encode at least one of the selected frequency components to a non-zero value using a number of bits less than or equal to a predetermined number of bits allocated for the current encoding stage.

### TECHNICAL FIELD

The present application relates generally to audio coding.

### BACKGROUND

In recent years coding of speech and audio signals has moved more towards preserving the presence information of the input signal also in the reconstructed output signal—or at least sharing some of the presence information for the receiving end—instead of merely coding the primary audio content. Instead of traditional monophonic coding, different forms of audio scene decompositions such as stereo, binaural, and multichannel coding are exploited to include the presence information (e.g. spatial information) in the transmission. Conceptually, an audio scene can be divided into a directional sound source(s) and the surrounding ambience—termed presence information. Although the actual (directional) sound sources can be considered as the main component of the audio image, it may be desirable that the surrounding ambience can be restored properly at the receiving side to enable the feeling of presence for the end-user.

A traditional coding technique for including presence information in the encoded signal is sum-difference coding, known also as the Mono/Side (MS) coding technique. In MS stereo coding, the left and right channels are transformed into sum and difference signals, as described e.g. in J. D. Johnston and A. J. Ferreira, “Sum-difference stereo transform coding”, ICASSP-92 Conference Record, 1992, pp. 569-572. For multichannel signals comprising more than two channels, the difference is typically determined between selected channel pairs. The sum signal can be considered the main (single-channel) audio component, and it is typically encoded using a traditional audio coding technique. The difference signal represents the presence signal, and it is typically encoded using a tailored MS coding technique. The difference signal may be coded on a frequency band basis, possibly also exploiting psychoacoustical information that indicates the amount of quantization noise that can be introduced to each band without audible degradation.

A similar technique tailored somewhat more towards low bitrate coding is discussed in Kalervo Kontola, Jari M. Makinen, Anisse Taleb, Stephan Bruhn, Bruno Bessette, Redwan Salami, “AMR-WB+: Low Bit Rate Audio Coding for Mobile Multimedia”, IEEE Symposium on Broadband Multimedia Systems and Broadcasting, 2006. Yet another approach to include presence information in the encoded signal, based on synthetic restoration of the original presence signal, is provided in Purnhagen, Heiko; Engdegard, Jonas; Roden, Jonas; Liljeryd, Lars, “Synthetic Ambience in Parametric Stereo Coding”, AES 116^{th Convention,} May 2004, preprint 6074. A recent technique for providing a multi-channel encoded audio with presence information is parametric multi-channel coding, such as Binaural Cue Coding (BCC), described e.g. in Baumgarte, F. and Faller, C. “Binaural Cue Coding—Part II Schemes and Applications” IEEE Transactions on Speech and Audio Processing, Vol. 11, No 6, November 2003.

### SUMMARY

Various aspects of examples of the invention are set out in the claims.

According to a first aspect of the invention, there is provided an apparatus for encoding an audio signal in two or more encoding stages, the audio signal comprising a set of frequency components. The apparatus comprises a frequency component selection unit configured to select a number of frequency components from the set for encoding in a current encoding stage, the selected frequency components being components of the set that have not been encoded to a non-zero value in a preceding encoding stage; and an encoding unit configured to encode at least one of the selected frequency components to a non-zero value using a number of bits less than or equal to a predetermined number of bits allocated for the current encoding stage.

According to a second aspect of the invention, there is provided an apparatus for decoding an encoded audio signal in two or more decoding stages, the audio signal comprising a set of frequency components. The apparatus comprises a frequency component selection unit configured to select a number of frequency components of the set to be decoded in a current decoding stage, the selected frequency components being components of said set that have not been reconstructed to a non-zero value in a preceding decoding stage; and a decoding unit configured to decode the frequency components selected in the current decoding stage and to reconstruct a component of the audio signal based at least in part on the frequency components decoded in the current decoding stage.

According to a third aspect of the invention, there is provided a method for encoding an audio signal in two or more encoding stages, the audio signal comprising a set of frequency components. The method comprises selecting a number of frequency components from the set for encoding in a current encoding stage, the selected frequency components being components of the set that have not been encoded to a non-zero value in a preceding encoding stage, and encoding at least one of the selected frequency components to a non-zero value using a number of bits less than or equal to a predetermined number of bits allocated for the current encoding stage.

According to a fourth aspect of the invention, there is provided a method for decoding an encoded audio signal in two or more decoding stages, the audio signal comprising a set of frequency components. The method comprises selecting a number of frequency components of the set to be decoded in a current decoding stage, the selected frequency components being components of the set that have not been reconstructed to a non-zero value in a preceding decoding stage, decoding the frequency components selected in the current decoding stage and reconstructing a component of the audio signal based at least part on the frequency components decoded in the current decoding stage.

According to a fifth aspect of the invention, there is provided an apparatus for encoding an audio signal in two or more encoding stages, the audio signal comprising a set of frequency components. The apparatus comprises means for selecting a number of frequency components from the set for encoding in a current encoding stage, the selected frequency components being components of the set that have not been encoded to a non-zero value in a preceding encoding stage; and means for encoding at least one of the selected frequency components to a non-zero value using a number of bits less than or equal to a predetermined number of bits allocated for the current encoding stage.

According to a sixth aspect of the invention, there is provided an apparatus for decoding an encoded audio signal in two or more decoding stages, the audio signal comprising a set of frequency components. The apparatus comprises means for selecting a number of frequency components of said set to be decoded in a current decoding stage, the selected frequency components being components of the set that have not been reconstructed to a non-zero value in a preceding decoding stage; means for decoding the frequency components selected in the current decoding stage; and means for reconstructing a component of the audio signal based at least in part on the frequency components decoded in the current decoding stage.

According to a seventh aspect of the invention, there is provided a computer program for encoding an audio signal in two or more encoding stages, the audio signal comprising a set of frequency components. The computer program comprises code for selecting a number of frequency components from the set for encoding in a current encoding stage, the selected frequency components being components of the set that have not been encoded to a non-zero value in a preceding encoding stage; and code for encoding at least one of the selected frequency components to a non-zero value using a number of bits less than or equal to a predetermined number of bits allocated for the current encoding stage.

According to an eighth aspect of the invention, there is provided a computer program for decoding an encoded audio signal in two or more decoding stages, the audio signal comprising a set of frequency components. The computer program comprises code for selecting a number of frequency components of the set to be decoded in a current decoding stage, the selected frequency components being components of the set that have not been reconstructed to a non-zero value in a preceding decoding stage; code for decoding the frequency components selected in the current decoding stage; and code for reconstructing a component of the audio signal based at least part on the frequency components decoded in the current decoding stage.

According to a ninth aspect of the invention, there is provided a computer program product comprising a computer-readable medium bearing a computer program according to the seventh and/or the eighth aspect of the invention.

According to a tenth aspect of the invention, there is provided an encoded representation of an audio signal, the audio signal comprising a set of frequency components. The encoded representation comprises a predetermined number of encoded data components, the data components corresponding to a predetermined number of encoding stages, an encoded data component corresponding to a particular encoding stage comprising an encoded representation of a number of frequency components selected from the set of frequency components for encoding at the particular encoding stage, the selected frequency components being components of the set that have not been encoded to a non-zero value in a preceding encoding stage. The selected frequency components are represented in the encoded data component using a number of bits less than or equal to a predetermined number of bits allocated for the current encoding stage.

According to an eleventh aspect of the invention, there is provided a computer program product comprising a computer readable medium bearing an encoded representation of an audio signal according to the tenth aspect of the invention.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an audio coding system according to an embodiment of the invention;

FIG. 2 illustrates an encoder according to an embodiment of the invention;

FIG. 3 presents a flowchart illustrating the operation of a presence encoding unit according to an embodiment of the invention;

FIG. 4 illustrates a presence encoding unit according to an embodiment of the invention;

FIG. 5 illustrates a decoder according to an embodiment of the present invention.

FIG. 6 presents a flowchart illustrating the operation of a presence decoding unit according to an embodiment of the invention.

FIG. 7 illustrates a presence decoding unit according to an embodiment of the invention; and

### DETAILED DESCRIPTION OF THE DRAWINGS

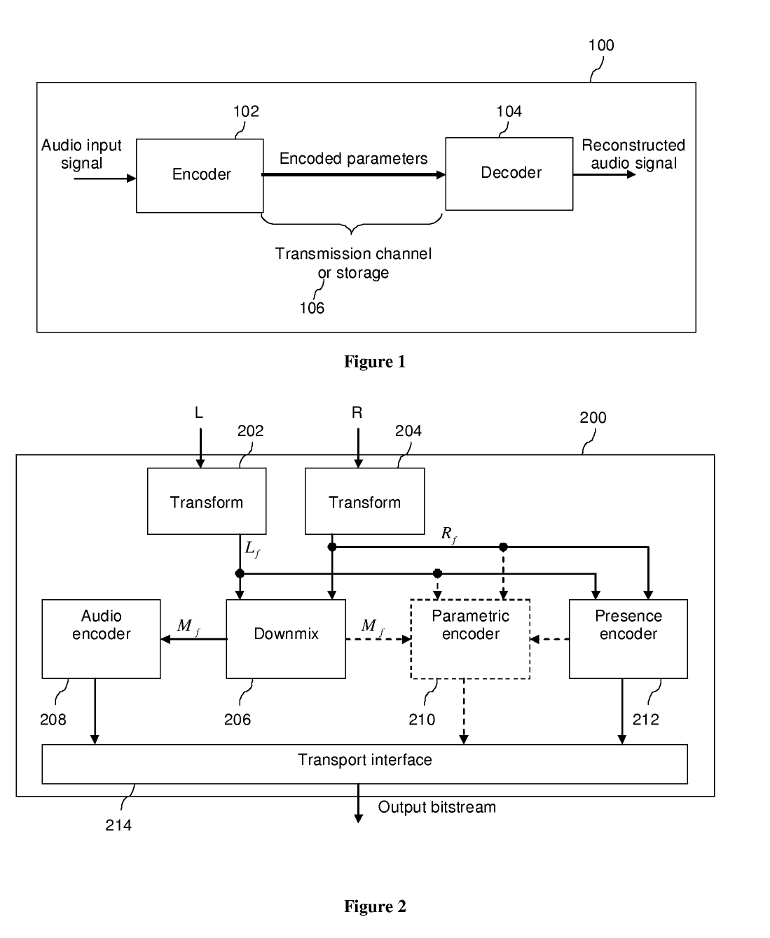

Example embodiments of the present invention and their potential advantages are best understood by referring to FIGS. 1 through 7 of the drawings.

FIG. 1 illustrates an audio coding system 100 according to an embodiment of the invention, comprising an encoder 102, a decoder 104, and a transmission channel or storage element 106. Encoder 102 encodes an input audio signal, comprising two or more channels, into a set of encoded audio parameters representative of the input signal. Decoder 104 processes received encoded parameters and provides a reconstructed audio signal as output. The input audio signal may be divided, in the time domain, into a sequence of (consecutive) frames, and encoder 102 and decoder 104 may be configured to process the signal on frame-by-frame basis. The frames may or may not be overlapping in time.

FIG. 2 illustrates an encoder 200 according to an embodiment of the invention. In the example of FIG. 2, encoder 200 is configured to receive and encode a two-channel (stereo) time domain audio input signal comprising left (L) and right (R) channels. It should be noted, however, that a two-channel signal is used here merely for the purpose of illustration and may be generalized to any number of channels.

In encoder 200 the time-domain left channel input signal L is transformed by transform unit 202 to form a frequency domain representation L_{f}. In a similar manner, the time-domain right channel input signal R is transformed by transform unit 204 to form a frequency domain representation R_{f}. Alternatively, a single transform unit may be configured to perform the transform for each channel of the input signal. Any suitable time-to-frequency domain transformation may be used, for example a Discrete Fourier Transform (DFT), a combination of Modified Discrete Cosine Transform (MDCT) and Modified Discrete Sine Transform (MDST), or a complex valued Quadrature Mirror Filterbank (QMF).

In the embodiment shown in FIG. 2, downmix unit 206 determines a downmix signal M_{f} using the transform-domain input signals L_{f} and R_{f}. Downmix signal M_{f} may be determined, for example, according to the expression M_{f}=0.5 (L_{f}+R_{f}). The signal M_{f} is referred to as a downmix signal, since it represents the input signal using a smaller number of channels than the input itself.

In other embodiments, a different method for combining the transform-domain input signals to form the downmix signal M_{f} may be used. The downmix signal may be created, for example, by computing a weighted sum of the input signals, or by selecting only one of the input signals as the downmix signal. Furthermore, pre-processing may be applied to the transform-domain input signals prior to forming the downmix signal. Alternatively, pre-processing may be applied to the time-domain input signals prior to transformation into the frequency domain. One example of such pre-processing is time-alignment of input channels prior to combining the signals. Another example of pre-processing is division of the input signals into a number of frequency bands, and determining the downmix signal separately for some or all of the frequency bands.

In embodiments configured to process more than two input channels, the downmix unit 206 may be configured to determine the downmix signal M_{f} comprising one or more channels. The channels of the downmix signal M_{f} may be determined as a linear combination of the input signals, or as a linear combination of a subset of the input signals. Alternatively, the channels of the downmix signal M_{f} may comprise one or more of the input signal channels. Furthermore, pre-processing may be applied to the input signal channels prior to determining the downmix signal M_{f}, as described above. As an example, a two-channel downmix signal, comprising channels M_{f1} and M_{f2}, may be determined based on a 5-channel input, comprising left front channel L^{f} right front channel R^{f}, left rear channel L^{r}, right rear channel R^{r} and a center channel C in such a way that M_{f1}=L^{f}+L^{r}+0.5*C and M_{f2}=R^{f}+R^{r}+0.5*C.

Returning to the embodiment illustrated in FIG. 2, audio encoder unit 208 encodes the downmix signal provided by downmix unit 206, and passes the encoded downmix signal to transport interface 214. In case the downmix signal M_{f} comprises a single channel, a mono encoder such as, for example, the Advanced Audio Codec (AAC), Enhanced Advanced Audio Codec (AAC+) or International Telecommunication Union Standardization Sector (ITU-T) Recommendation G.718 codec may be used. Transport interface 214, which prepares the output bitstream of encoder 200 based at least part on encoded parameters, is described below in more detail.

In embodiments in which the downmix signal M_{f} comprises multiple channels, each channel may be encoded separately in the audio encoder unit 208, and a separate encoded downmix signal provided to the transport interface 214 for each of the channels of the downmix signal M_{f}. Hence, each channel of the downmix signal M_{f} may be encoded separately using, for example, AAC, AAC+ or G.718 codec.

In FIG. 2, the transform-domain left and right channels L_{f} and R_{f}, respectively, are provided to presence encoding unit 212 for further processing. In one embodiment, presence encoding unit 212 determines a presence signal in the form of a difference signal diff_{f}, which is then encoded. In an embodiment, difference signal diff_{f} is determined according to the expression diff_{f}=0.5 (L_{f}−R_{f}). The encoded presence signal is then passed to transport interface 214.

In some embodiments, encoder 200 comprises a parametric encoder 210, which may be configured to apply a parametric encoding technique, such as BCC, to encode at least part of the presence information. Parametric encoder 210 may determine encoded parametric information based at least in part on transform-domain input signals L_{f} and R_{f}. Furthermore, in some embodiments the downmix signal M_{f} determined in downmix unit 206 may also be used as an input to parametric encoder 210. The encoded parametric information may comprise cues such as Inter-Channel Level Difference (ICLD), Inter-Channel Time Difference (ICTD), and Inter-Channel Coherence (ICC), determined for one or more frequency bands of the input signal. As an example, the ICLD cue for a given frequency band may be determined as a ratio of signal energies between the input channels in respective frequency bands, the ICTD cue for a given frequency band may be determined as temporal difference that provides a (local) maximum of normalized correlation between the input channels in respective frequency bands, and the ICC cue for a given frequency band may be determined as the normalized correlation corresponding to the determined ICTD value in respective frequency band. Thus, these parameters may be used to describe the relationship between the channels of the input signal in terms of signal level, temporal alignment, and correlation, respectively. Together with a downmix signal, one or more of the ICLD, ICTD and ICC cues enable reconstruction of a two-channel signal providing an approximation of the audio image present in the input signal. The encoded parametric information is passed to transport interface 214. In an embodiment, parametric encoder 210 determines the encoded parametric information independently of the presence encoding in presence encoding unit 212, while in other embodiments, parametric encoder 210 may use information from the encoding process in presence encoding unit 212, for example the encoded presence signal, as further input for the encoding process.

In an embodiment configured to process a multi-channel input signal, parametric encoder 210 may receive more than two input signal channels transformed into the frequency-domain. The parametric cues, for example ICLD, ICTD and ICC as describe above, may be determined, for example, for each of the input channels with respect to the downmix signal, or with respect to a particular one or a particular subset of the downmix signals, if multiple downmix signal channels are employed.

In an embodiment, the encoded presence signal output from presence encoding unit 212 and the encoded parametric information output from parametric encoder 210 provide information relating to the same frequency components of the input signal. Thus, the encoded presence signal provided by presence encoding unit 212 may overlap to some extent in terms of information content with the encoded parametric information provided by parametric encoder 210, thereby possibly providing two different encoded versions representing the same frequency components of the input signal. The overlap may be partial, over only a part of the operating frequency range of the system, or the output signals from parametric encoder 210 and presence encoding unit 212 may overlap across the whole frequency range.

In yet another embodiment, presence encoding unit 212 may be configured to encode the presence information for a first subset of frequency components, and parametric encoder 210 may be configured to encode the presence information for a second subset of frequency components. The first and second subsets may cover the full frequency range, or there may be a third subset of frequency components that is encoded by some other technique, or which is excluded at least in part from the presence encoding process. As an example, the encoded presence information representative of an input signal may be divided into three frequency bands, which may or may not be overlapping in frequency. Furthermore, the presence encoding unit may be used to encode the lowest of the three frequency bands, a parametric encoding technique may be used to encode the mid-band, whereas the highest frequency band may not be encoded at all.

In an embodiment configured to process a multi-channel input signal, presence encoding unit 212 may obtain a separate difference signal for each input channel pair or for a subset of input channel pairs. Some or each of the difference signals may be encoded separately. In alternative embodiments, a predetermined subset of the difference signals may be encoded separately and a predetermined combination of the remaining difference signals may be coded jointly. An example of a multi-channel input signal is a 5-channel configuration comprising left front channel L^{f}, right front channel R^{f}, left rear channel L^{r}, right rear channel R^{r}, and a center channel C. In one embodiment, the left and right front channels L^{f} and R^{f} form one channel pair, and the left and right rear channels L^{r} and R^{r} form another channel pair. In another embodiment, the front left and rear left channels L^{f} and L^{r} form a channel pair, and the front right and rear right channels R^{f} and R^{r} form another channel pair. The processing in presence encoding unit 212 may be performed for all determined channel pairs, or for only a limited set of determined channel pairs. The channel pairs to be processed and encoded may be decided, for example, based at least in part on an audio activity or energy level in the respective input channels. As an example, if most of the audio activity is concentrated in a certain channel pair or in a subset of channel pairs, the encoded presence information may be provided only for the channel pairs indicating significant audio activity. As an example, a signal having an energy exceeding a pre-determined threshold may be considered to indicate significant audio activity. A channel pair comprising a channel indicating significant audio activity may be considered a channel pair with significant audio activity.

Transport interface 214 processes the inputs from audio encoder unit 208, from presence encoding unit 212, and from parametric encoder 210, if present. In one embodiment, transport interface 214 acts as a multiplexer, and is configured to combine the encoded downmix signal from audio encoder unit 208, the encoded presence signal from presence encoding unit 212, and encoded parametric information from parametric encoder 210 (if present) into a single encoded component. The transport interface provides this component as an output bitstream representative of the particular input frame from which the various parameters were derived.

In some embodiments, transport interface 214 may construct an output bitstream having a layered structure. The transport interface may, for example, distribute the encoded parameters representing an input frame to several encoded components. An example of such a layered design is to provide one encoded component comprising the encoded downmix signal from audio encoder unit 208, another encoded component comprising the encoded presence signal from presence encoding unit 212, and a third encoded component comprising the encoded parametric information from parametric encoder 210, if present. Another example of a layered bitstream design may further divide the encoded presence signal from presence encoding unit 212 into two or more separate encoded components. Yet another example is to provide a dedicated encoded component for a subset of frequency components, each encoded component comprising a respective subset of frequency components of the encoded downmix signal from audio encoder unit 208, a respective subset of the encoded presence signal from presence encoding unit 212, and a respective subset of encoded parametric information from parametric encoder 210, if present. In such an example embodiment, each subset may cover a respective frequency range of the signal in question. Transport interface 214 may provide the encoded component(s) for transmission or for storage.

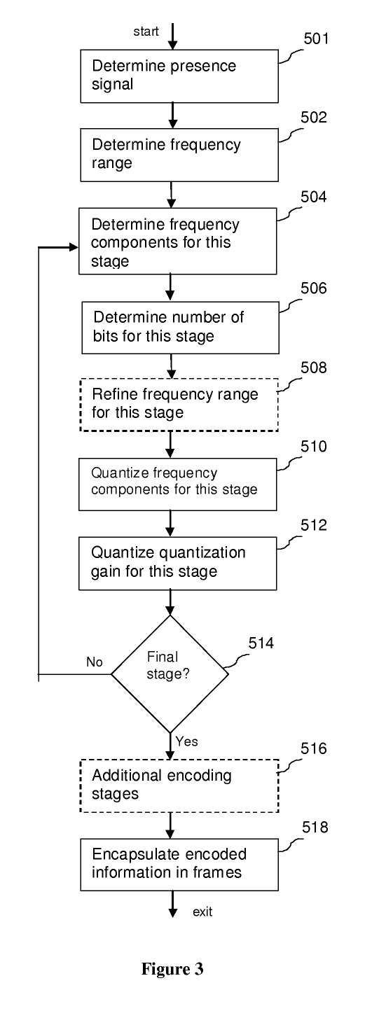

FIG. 3 presents a flowchart illustrating the operation of a presence encoding unit according to an embodiment of the invention. In the illustrated embodiment, the encoding method comprises N encoding stages. At step 501, a presence signal is determined for a frame of the audio input signal, for example as described in connection with FIG. 2. At step 502, the frequency range to be encoded is selected from among a set of available frequency range candidates and information identifying the selected frequency range is provided for inclusion in an output frame. The selection of a suitable frequency range may be made based at least in part upon the characteristics of the input signal.

At step 504 frequency components to be encoded in the current encoding stage are chosen. The selection is made in such a way that frequency components quantized to a non-zero value in earlier encoding stages are excluded from the encoding process in the current stage. The number of bits used for quantization of the frequency components at the current encoding stage is determined at step 506. Information concerning the number of bits used for quantization of frequency components at the current encoding stage may be provided for inclusion in the output frame.

At step 508, the selected frequency range may be refined by excluding some of the frequency components from the lower frequency end of the selected frequency range and/or by excluding some of the frequency components from the higher frequency end of the selected frequency range from the encoding process at this stage. If frequency range refinement is performed at a particular encoding stage, frequency range tuning information indicative of the excluded frequency components at the lower and/or higher end of the selected frequency range may also be provided for inclusion in the output frame.

At step 510 the chosen frequency components in the selected (and possibly refined) frequency range are quantized. The quantized frequency components are provided for inclusion in the output frame. A quantizer gain for the frequency component quantization is defined at step 512. The quantizer gain is itself quantized and provided for inclusion in the output frame. In step 514 a test is performed to determine whether the current encoding stage was the final stage in the encoding process. In the case that the current stage was not the final encoding stage, the next encoding stage is started and the method continues from the step 504. In the case that the current stage was the final encoding stage, the process exits the loop comprising method steps 504 to 514 and processing continues from step 516.

Step 516 represents an additional encoding stage that may be performed if remaining bits are available after completion of N encoding stages. The number of bits available for the additional encoding stage is determined and a number of frequency components is selected for encoding from among the frequency components that were not quantized to a non-zero value in any of the preceding N encoding stages. The selected frequency components are quantized using at least some of the remaining bits available for the additional encoding stage. A corresponding quantizer gain for the additional encoding stage is determined and quantized. The quantized frequency components and the quantized quantization gain for the additional encoding stage are provided for inclusion in the output frame. In embodiments of the invention, more than one additional encoding stage 516 may be performed, for example, if there are sufficient bits available after completion of the N encoding stages.

In the final step 518, the information derived in the encoding process is encapsulated into one or more output frames. As described in connection with FIG. 2, in embodiments of the invention, a single encoded component may be formed for each frame of the audio input signal, the single encoded component comprising the encoded downmix signal from audio encoder 208, an encoded presence signal from presence encoding unit 212 and encoded parametric information from parametric encoder 210, if present. In other embodiments, a separate output frame of encoded presence information may be provided for each audio input frame.

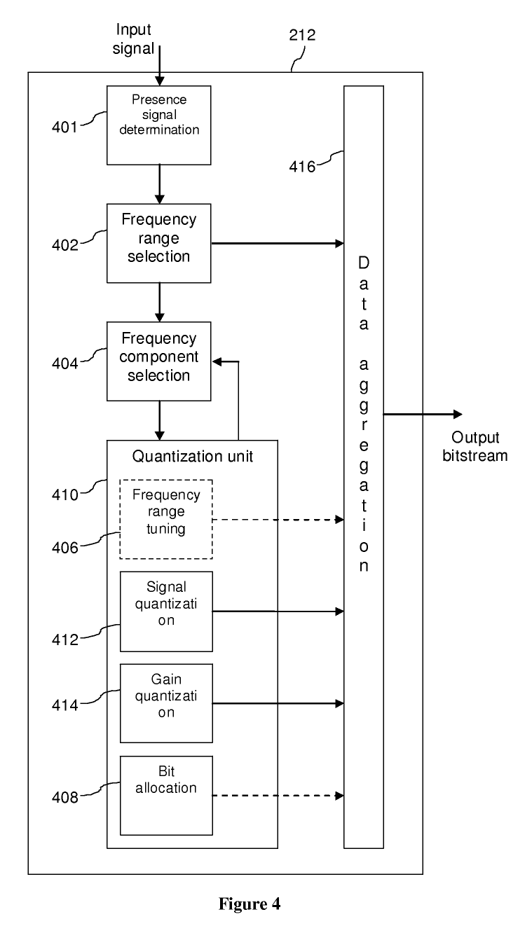

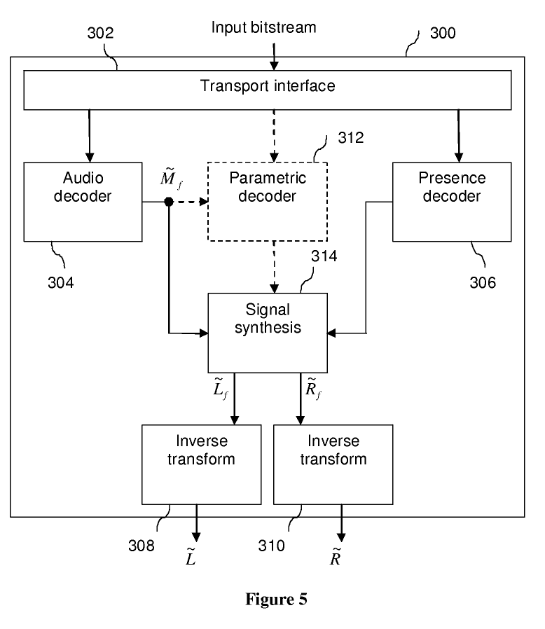

FIG. 4 illustrates a presence encoding unit 212 according to an embodiment of the invention, implemented to encode presence information in accordance with the example encoding method described in connection with FIG. 3. In the illustrated embodiment, presence encoding unit 212 comprises a presence signal determination unit 401, a frequency range selection unit 402, a frequency component selection unit 404, a quantization unit 410, and a data aggregation unit 416. In embodiments in which the full frequency range, or a predetermined part of the frequency range, is used when encoding the presence signal, frequency range selection unit 402 may not be present.

Presence encoding unit 212 receives an input signal comprising two or more channels, and provides an output bitstream comprising an encoded representation of the presence signal. In the illustrated embodiment, presence encoding unit 212 is configured to encode the presence signal by applying an N-stage encoding process, where N is an integer number larger than or equal to 2. The encoded representation of the presence signal may comprise encoded signal components of the presence signal. The encoded representation of the presence signal may further comprise information about the frequency range of the encoded presence signal.

In the embodiment of FIG. 4, the input signal to the presence encoding unit is provided to presence signal determination unit 401, which derives a presence signal based at least part on the input signal. The presence signal may be determined, for example, as a difference signal between the channels of the frequency-domain input signal, as described in connection with FIG. 2.

In embodiments comprising a frequency range selection unit 402, the presence signal determined by presence signal determination unit 401 may be provided as input to frequency range selection unit 402. In such an embodiment, frequency range selection unit 402 determines a frequency range for encoding the presence information in the input signal and provides information on the determined frequency range to data aggregation unit 416, e.g. for inclusion in the output bitstream of presence encoding unit 212.

Frequency range selection unit 402 may select a frequency range from among a number of frequency range candidates, the selected frequency range comprising the most significant frequency components of the presence signal, for example, the ones with the highest magnitudes. As an example, the selection can be performed according to equation (1) below:

$$\begin{matrix}eOffset ( i ) = {\sum }_{j = startOffsetTbl [ i ]}^{startOffsetTbl [ i ] + M} {e}_{S} ( j ) & 0 \leq i < K\end{matrix} \qquad ( 1 )$$

where startOffsetTbl describes the respective starting index for each of the frequency range candidates, eₛ(j) denotes the magnitude difference between the channels of the input signal at frequency component j according to equation (2), M denotes the extent of the frequency range as a number of frequency components, and K is the number of different frequency range candidates available. In one embodiment, the following values are used: startOffsetTbl[ ]={0, 4, 9, 15, 21, 29, 39, 51}, K=8, M=160. As an example, in case 25 Hz frequency resolution is used, the table startOffsetTbl describing the starting index maps to starting frequencies {0, 100, 375, 525, 725, 975, 1275} Hz. Thus, in this example increasing an index value by 1 implies increasing the respective frequency by 25 Hz, and considering the example value of M=160 the extent of frequency range equals M*25=4000 Hz.

Furthermore, eₛ in equation (1) is given by:

e_{S}(i)=| f̅_{L}(i)− f̅_{R}(i)|, 0≦i<F (2)

where F is the length of a frame in the frequency domain, specified as a number of frequency components, and f̅_{L} and f̅_{R} are the frequency domain representations of the left and right channel input signals, respectively. As explained in connection with the description of transform units 202 and 204, the complex-valued representations of the input channels may be obtained, for example, using a DFT, a combination of MDCT and MDST, a complex-valued QMF, or any other suitable time-to-frequency domain transformation. The frequency range of the presence signal to which the encoding process will be applied may be selected by searching for the maximum of equation (1) and determining a corresponding offset table index, for example, according to the following algorithm:

fStart=maxᵢ(eOffset)

fStartOffset=startOffsetTbl[fStart] (3)

The value of fStart is provided to data aggregation unit 416 for inclusion in the output bitstream of presence encoding unit 212. In embodiments in which frequency range selection unit 402 is configured to select a frequency range from amongst a predetermined number of candidate ranges, each of the predetermined candidate ranges having a specified starting frequency and a predetermined number of spectral bins M, the value of fStart is sufficient to characterize the properties of the selected range. Thus, inclusion of fStart in the output bistream is sufficient to enable a corresponding decoder to identify the selected frequency range when decoding the encoded presence signal.

In one embodiment, only one of the K possible frequency ranges is selected for each frame, and this is used in the encoding process across all encoding stages. In other embodiments various modifications of the frequency range selection logic described above may be applied. For example, the full frequency range of the presence signal may be selected for encoding. Alternatively, a predefined subset of the full frequency range of the presence signal may be used. In another example, the extent of the frequency range, as indicated, for example, by the value of M, may be different for different frequency range candidates. In a further example, the value of M may be varied from frame to frame, for example based on characteristics of the input signal, based on characteristics of the presence signal, based on an available number of bits, or based on preferences set by an application or a user. In such an embodiment the value of M is included in the output bitstream to make the value available for a corresponding decoder. At least some of the frequency range candidates may partially overlap in frequency. Alternatively, the frequency range candidates may be non-overlapping. In one example, the frequency range candidates may comprise two or more sub-ranges that are discontinuous in frequency domain. In yet another example, a criterion different from equation (1) may be used to select the frequency range for encoding.

In embodiments of the invention that do not comprise a frequency range selection unit 402, the frequency range selected for encoding may be the full frequency range, comprising all frequency components of the presence signal, or any predetermined subset of the frequency components of the presence signal.

In the embodiment of presence encoder 212 illustrated in FIG. 4, frequency component selection unit 404 chooses the frequency components to be encoded at a current encoding stage of the N-stage encoding process. Frequency component selection unit 404 chooses the frequency components within the selected frequency range or ranges that have not yet been quantized to a non-zero value in one of the earlier encoding stages. For the purposes of illustration, this may be done according to example pseudo code (A) presented below.

Example pseudo code (A)

1: nBins = 0
2: For(j = 0; j < M; j++)
3: If qCoef[fStartOffset + j] == 0
4: inQ_Coef[nBins] = diff_{f} [fStartOffset + j]
5: Increase nBins by 1

In example pseudo code (A), the variable qCoef is an array configured to hold the values of the frequency components quantized so far. Before starting the N-stage encoding process, the entries in the qCoef array are initialized to zero. As can be seen on line 3 of the example pseudo code (A), only the frequency components quantized to a non-zero value are chosen for quantization in the current encoding stage. The unquantized values of these frequency components are provided in the variable inQ_Coef, and variable nBins counts the number of non-zero-valued frequency components. At the first stage of the N-stage encoding process all frequency components within the selected frequency range are chosen for quantization in the current (first) encoding stage.

In the embodiment of the invention illustrated in FIG. 4, quantization unit 410 of presence encoding unit 212 is configured to provide encoded signal components for the N encoding stages, together with corresponding quantized quantizer gains. As illustrated, quantization unit 410 comprises a signal quantization unit 412, a gain quantization unit 414, a bit allocation unit 408, and a frequency range tuning unit 406.

In the illustrated embodiment, frequency range tuning unit 406 is configured to perform a further frequency component selection based at least in part on the frequency components provided by the frequency component selection unit 404 and to provide frequency range tuning information to data aggregation unit 416 for inclusion in the output bitstream of the presence encoding unit. In embodiments that do not apply frequency range tuning, frequency range tuning unit 406 may be omitted, and quantization unit 410 is configured to operate using the frequency range provided by frequency component selection unit 404 without modification.

Frequency range tuning unit 406 may further limit the frequency range over which the encoded representation of the presence signal is determined. This may have the technical effect of improving perceptual quality. In one embodiment, frequency range tuning unit 406 is configured to limit the frequency range subject to encoding in such a way that the number of frequency components quantized to a non-zero value is increased. This may be achieved for example as follows: First, frequency range tuning unit 406 performs a check to determine whether limiting the frequency components at the higher frequency end of the selected frequency range would increase the number of frequency components quantized to a non-zero value, for example according to the iterative process presented in example pseudo code (B) presented below:

Example pseudo code (B)

```
  1: Set T = 0, nQ_max = 0, nQ_Idx1 = 0
  2: Reduce nBins by T; nBins_new = nBins − T
  3: Quantize components in inQ_Coef from indices 0 to nBins_new
  4: Count number of non-zero quantized values, set value to nQ
  5: If nQ > nQ_max
  6: nQ_max = nQ
  7: nQ_Idx1 = T / T_inc1
  8: If T < T_limit1
  9: Increase T; T = T + T_inc1
  10: Goto 2
  11: Else
12: nBins = nBins − nQ_Idx1 * T_inc1
13: Exit
```

In example pseudo code (B) variable T describes a candidate value for the number of frequency components to be excluded at the higher frequency end of the selected frequency range in a current iteration round, nQ indicates the number of frequency components that are quantized to a non-zero value when this value of T is used, nQ_max indicates the largest number of non-zero valued quantized frequency components obtained so far, and nQ_Idx1 is the encoded value of T. Furthermore, variable nBins is used to indicate the number of frequency components selected for quantization by frequency component selection unit 404, inQ_coef is a variable holding the unquantized frequency components of the presence signal covering the frequency range(s) selected by frequency component selection unit 404, and T_inc1 is the step size by which the value of T is increased between iteration rounds.

On line 1 of example pseudo code (B), the variables are initialized. On line 2 a new value for the number of frequency components T to be excluded is used to set the value of variable nBins_new to indicate the number of frequency components to be quantized in current iteration round. On line 3, a number of frequency components are quantized using a number of bits available for use at the current encoding stage. In the example embodiment illustrated in FIG. 4, this operation is performed by signal quantization unit 412. The frequency components to be quantized are held by variable inQ_Coef, which are the frequency components chosen by frequency component selection unit 404 within the frequency range selected by frequency range selection unit 402. The number of frequency components to be quantized is indicated by variable nBins, and the T highest frequency components of selected frequency range are excluded from quantization. The number of bits available for the current encoding stage is indicated by bit allocation unit 408.

On line 4, the resulting number of frequency components quantized to a non-zero value nQ is computed. In the example embodiment of FIG. 4, this operation is performed in frequency tuning unit 406. On lines 5-7 of example pseudo code (B) a test is performed to determine whether the value of nQ obtained using the current value of T is greater than the highest value obtained so far, as indicated by variable nQ_max. If the value of nQ obtained with the current choice of T exceeds the previously obtained highest value nQ_max, variable nQ_max is set equal to the number of non-zero quantized components obtained with the current value of T (line 6 of example pseudo code (B)). At line 7 variable nQ_Idx1 is set to the value T/T_inc1 to indicate the number of the iteration round representing the new selection.

On line 8, a test is performed to determine whether all valid values of T have been considered. In a situation in which all valid values of T have not yet been considered, the value of T is increased by T_inc1 at line 9 of the pseudo code and line 10 causes the processing to continue from line 2. If, on the other hand, all valid values of T have been considered (line 11), the extent of selected frequency range is limited by setting the value of nBins based on the selected value of nQ_Idx1 (line 12 of the pseudo code). The frequency range tuning process according to example pseudo code (B) is terminated at line 13.

In embodiments that employ frequency range tuning, frequency range tuning unit 406 may perform a further check to determine whether limiting the frequency components at the lower frequency end of the selected frequency range would further increase the number of frequency components that are quantized to a non-zero value. This may be done, for example, according to an iterative process, as illustrated in example pseudo code (C), presented below:

Example pseudo code (C)

```
  1: Set T = 0, nQ_Idx2 = 0, jOffset = 0
  2: Quantize components in inQ_Coef from indices T to nBins
  3: Count number of non-zero quantized values, set value to nQ
  4: If nQ > nQ_max
  5: nQ_max = nQ
  6: nQ_Idx2 = T / T_inc2
  7: If T < T_limit2
  8: Increase T; T = T + T_inc2
  9: Goto 2
10: Else
11: jOffset = nQ_Idx2 * T_inc2
12: Exit
```

In example pseudo code (C) variable T describes a candidate value for the number of frequency components to be excluded at the lower frequency end of the selected frequency range in a current iteration round, nQ_Idx2 is the encoded value of T and T_inc2 is the step size by which the value of T is increased between iteration rounds. All other parameters have the same meanings as explained above in the context of example pseudo code (B).

Now referring in detail to example pseudo code (C), on line 1 the variables are initialized. The variable nQ_max is not initialized, but the value of nQ_max at the termination of the iteration process presented in example pseudo code (B) is used as the starting value. Furthermore, the variable nBins is not initialized but the value obtained as a result of processing according to example pseudo code (B) is kept (or alternatively, the variable nBins may be initialized to a value obtained as a result of processing according to example pseudo code (B)). On line 2, a number of frequency components are quantized using a predetermined number of bits available for use at the current encoding stage. In the example embodiment illustrated in FIG. 4, this operation is performed by signal quantization unit 412. The frequency components to be quantized are held by variable inQ_Coef, which are the frequency components chosen by frequency component selection unit 404 within the frequency range selected by the frequency range selection unit 402. The number of frequency components to be quantized is indicated by variables T and nBins in such a way that nBins frequency components starting from the T:th frequency component are quantized. The number of bits available for the current encoding stage is indicated by bit allocation unit 408.

On line 3 the resulting number of frequency components quantized to a non-zero value nQ is computed. In the example embodiment of FIG. 4, this operation is performed in frequency range tuning unit 406. On lines 4-6 of example pseudo code (C) a test is performed to determine whether the value of nQ, obtained using the current value of T is greater than the highest value obtained so far, as indicated by variable nQ_max. If the value of nQ obtained with the current choice of T exceeds the previously obtained highest value nQ_max, variable nQ_max is set equal to the number of non-zero quantized components obtained with the current value of T (line 5 of example pseudo code (C)). At line 6 variable nQ_Idx2 is set to the value T/T_inc2 to indicate the number of the iteration round representing the new selection.

On line 7, a test is performed to determine whether all valid values of T have been considered. In a situation in which all valid values of T have not yet been considered, the value of T is increased by T_inc2 at line 8 of the pseudo code and line 9 causes the processing to continue from line 2. If, on the other hand, all valid values of T have been considered (line 10), the extent of selected frequency range is limited by setting the variable jOffset based on the selected value of nQ_Idx2 (line 11 of the pseudo code). The process according to example pseudo code (C) is terminated at line 12.

In the example embodiment described above, two tests are performed, and as a result, the frequency components selected by frequency component selection unit 404 may be further limited both from the lower frequency end of the selected frequency range and respectively from the higher frequency end of the selected frequency range. In alternative embodiments, frequency range tuning unit 406 may only limit the frequency components at the lower end of the frequency range selected by frequency component selection unit 404. In other alternative embodiments, frequency range tuning unit 406 may limit the frequency components only at the higher end of the frequency range selected by frequency component selection unit 404. In yet other embodiments, frequency range tuning unit 406 may be configured to limit the frequency components selectively, either only at the lower end of the frequency range selected by frequency component selection unit 404, or only at the higher end of the frequency range. As an example, frequency range tuning unit 406 may first try to limit the frequency components at the higher end of the frequency range selected by frequency component selection unit 404. If limiting the frequency components at the higher end of the frequency range is found to improve perceptual quality, limitation at the higher end of the frequency range is applied and no further frequency range limitations are considered. On the other hand, if limiting the frequency components at the higher end of the frequency range is found not to improve perceptual quality, another check is performed to see if the limiting the frequency components at the lower end of the frequency range selected by frequency component selection unit 404 improves perceptual quality. If affirmative, limitation at the lower frequencies is applied.

In the embodiment of the invention illustrated in FIG. 4, frequency range tuning is performed for each encoding stage separately. In alternative embodiments, frequency range tuning unit 406 may be configured to apply frequency range tuning only at certain encoding stages. Furthermore, in some embodiments the frequency range tuning unit may be configured to apply a different frequency range tuning approach at different encoding stage. For example, at some encoding stages limitation of the selected frequency range may be only allowed at the higher frequency end of the frequency range, at some encoding stages limitation may be allowed only at the lower frequency end of the frequency range, and for some encoding stages limitation may be allowed both at the higher and lower ends of the frequency range.

In embodiments where frequency range fine tuning is applied at least for a subset of the encoding stages, the values of nQ_Idx1 and nQ_Idx2 are provided to data aggregation unit 416 for inclusion in the output bitstream of presence encoding unit 212, as frequency range tuning information. Information may also be provided to data aggregation unit 416 concerning the respective encoding stages at which frequency range fine tuning was applied.

In the embodiment of the invention illustrated in FIG. 4, the bit allocation for the current encoding stage is defined by bit allocation unit 408 of quantization unit 410. The overall bit budget B may be distributed evenly across the N encoding stages, implying that the number of bits allocated for each of the encoding stages is B/N. Alternatively, the number of bits allocated for different encoding stages may be different from stage to stage. Furthermore, the bit allocation may also be different from one input frame to another. As an example, a set of bit allocation combinations may be predefined. The set of bit allocation combinations may, for example, be selected to match a statistical bit distribution over a predefined set of input signals. As an example, such predefined set may comprise input signals of certain characteristics. The bit allocation combinations may be tailored, for example, to represent a desired range of dynamic range variations. This may have the technical effect of improving the efficiency and/or fidelity with which signals having different dynamic range characteristics may be quantized. For example, when quantizing a signal with a very high dynamic range, a bit allocation combination specifically designed for such a signal may be used, thereby allowing some of the encoding stages to use only a small number of bits and others to use a higher number of bits.

Bit allocation unit 408 provides the number of bits available for the current encoding stage to signal quantization unit 412 within quantization unit 410. In some embodiments, information concerning the bit allocation for a given encoding stage is provided to data aggregation unit 416 for inclusion to the output bitstream of presence encoding unit 212. In embodiments that employ a predefined bit allocation, information relating to the bit allocation may not be provided to data aggregation unit 416 and may not be provided in the output bitstream.

In embodiments of the invention, the frequency components of the presence signal determined by frequency component selection unit 404 (possibly further limited by frequency range tuning unit 406, if present) are quantized. In the embodiment illustrated in FIG. 4, quantization unit 410 quantizes the selected frequency components of the presence signal and stores the quantized values in variable inQ_Coe\hat{f}. Any suitable quantization method may be used to quantize the presence signal. For example, scalar quantization may be applied to individual frequency components. Alternatively, vector quantization may be applied to all or to a subset of frequency components of the determined frequency range, for example using the quantization technique described in U.S. Pat. No. 7,106,228. Some embodiments may use a combination of scalar quantization applied to selected ones of the frequency components, while certain other of the frequency components may be vector quantized. In embodiments of the invention, quantization unit 410 provides information concerning the bits used for quantization of the frequency components in the current encoding stage to bit allocation unit 408 of the quantization unit 410.

In embodiments of the invention employing a frequency range tuning unit 406, quantization unit 410 may exploit the quantization of frequency components performed as part of the frequency range fine tuning process. Referring to example pseudo code (B), presented above, quantized frequency components for a particular iteration round are generated at line 3. Frequency range tuning unit 406 may keep track of the quantized frequency components, for example by storing their values in an additional variable nQ_Coef1, in addition to variables nQ_max and nQ_Idx1 which indicate the currently selected frequency range. In a similar manner, referring to example pseudo code (C), quantized frequency components at a particular iteration round are determined at line 2 of the code. The additional variable nQ_Coef1 may also be used to keep a record of the quantized frequency components associated with the currently selected frequency range during this part of the frequency range fine tuning process. In such an embodiment the quantization of the presence signal frequency components performed during frequency range fine tuning can be effectively “re-used” by signal quantization unit 412, since the quantized frequency components are readily available in variable nQ_Coef1.

In the embodiment of the invention illustrated in FIG. 4, quantization unit 410 provides the quantized frequency components to data aggregation unit 416, for inclusion in the output bitstream of presence encoding unit 212. In embodiments of the invention, information concerning the encoding stage at which particular quantized frequency components were obtained may be also be provided to the data aggregation unit for inclusion in the output bitstream. Quantization unit 410 may update the variable qCoef comprising the values of the frequency components quantized so far, as indicated in example pseudo code (D) below:

Example pseudo code (D)

1: nBins = 0;
2: For(j = 0; j < M; j++)
3: If qCoef[fStartOffset + j] == 0
4: qCoef[fStartOffset + j] = inQ_Coe\hat{f}[nBins]
5: Increase nBins by 1

On line 4 of example pseudo code (D) the quantized frequency components are copied from variable inQ_Coe\hat{f} to variable qCoef, thereby updating the information on the frequency components quantized to a non-zero value so far. If the current encoding stage is not the final one, or if there are still some unused bits available, quantization unit 410 provides qCoef to the frequency component selection unit 404 to assist frequency component selection in the subsequent encoding stage.

In another embodiment, quantization unit 410 provides information on the frequency components quantized at the current encoding stage to frequency component selection unit 404, which performs an operation according to example pseudo code (D) prior to an operation according to pseudo code (C) to assist frequency component selection in the subsequent encoding stage.

In the embodiment of the invention illustrated in FIG. 4, gain quantization unit 414 is configured to determine a quantizer gain gIdx for the frequency components quantized in the current encoding stage. Quantizer gain gIdx may be determined, for example, according to equation (4):

$$ratio = \frac{{\sum }_{i = jOffset}^{nBins - 1} inQ\_Coef ( i ) \cdot inQ\_Coe \hat{f} ( i )}{{\sum }_{i = jOffset}^{nBins - 1} inQ\_Coe {\hat{f} ( i )}^{2}} \\ idx = ⌊ 12 \cdot {log}_{10} ( {ratio}^{2} ) + 0.5 ⌋ \\ gIdx = \{ \begin{matrix}0 , & idx < 0 \\ idx , & otherwise\end{matrix} \qquad ( 4 )$$

According to equation (4) the quantizer gain is calculated as a ratio between the cross-correlation of the unquantized and quantized frequency components, and the energy of the quantized frequency components. The ratio value is squared to improve the quantizer gain accuracy, converted to logarithmic domain, and finally rounded to integer value representation.

The quantizer gain gIdx determined according to equation (4) may be quantized using a selected number of bits. Bit allocation unit 408 determines the number of bits to be used in quantizing quantizer gain gIdx and provides an indication of the number of bits to be used to gain quantization unit 414. In embodiments of the invention, a larger number of bits may be used for quantizing the quantizer gain of the first encoding stage compared with the number of bits used for quantizer gain quantization in subsequent encoding stages. The number of bits used for quantizing the quantizer gain in subsequent encoding stages may be the same across all of the subsequent stages, or the number of bits may vary from stage to stage. As an example, seven bits may be used for quantizing the quantizer gain in the first encoding stage, and four bits may be used for quantization of the quantizer gain in all subsequent encoding stages. Alternatively, the number of bits used to quantize the quantizer gain at the n:th encoding stage may be reduced by quantizing the difference between the values of the quantization gain at the n:th encoding stage and the quantization gain at the (n−1):th encoding stage. In still other embodiments, quantization gain values less than or equal to a certain predetermined value are quantized as such, while in a situation where the difference between the encoding gain at the n:th and (n−1):th stage exceeds the predetermined value, the quantization gain at stage n is represented as the quantization gain at encoding stage (n−1) minus the predetermined value and this value is quantized. This approach is indicated in equation (5):

$${gIdx}_{n} = \{ \begin{matrix}{gIdx}_{n - 1} - 15 , & {gIdx}_{n - 1} - {gIdx}_{n} > 15 \\ {gIdx}_{n} , & otherwise\end{matrix} \qquad ( 5 )$$

where the subscript n refers to the number of the encoding stage.

In the embodiment of the invention illustrated in FIG. 4, gain quantization unit 414 provides the value of the quantization gain gIdx, determined for a particular encoding stage, to data aggregation unit 416 for inclusion in the output bitstream of presence encoding unit 212. In embodiments of the invention, information concerning the encoding stage to which a particular quantization gain value relates may also be provided to the data aggregation unit for inclusion in the output bitstream.

In the embodiment of the invention illustrated in FIG. 4, upon completion of the N-stage encoding process, bit allocation unit 408 performs a check to determine whether all bits available for the encoding of parameter values have been used. If bit allocation unit 408 determines that there are unused bits (bLeft) remaining after the N-stage encoding process has been completed, the remaining bLeft bits may be used, for example, for quantization of one or more frequency components which were not quantized to a non-zero value during the N encoding stages.

In one embodiment, one or more additional encoding stage is performed in the event that there are bits remaining for use. Bit allocation unit 408 provides quantization unit 410 with an indication of the number of bits bLeft available for the additional encoding stage(s) Frequency component selection unit 404 also provides quantization unit 410 with information identifying one or more of the frequency components that were quantized to a zero value during the N encoding stages. Quantization unit 410 processes the indicated frequency component(s) and may quantize at least some of them to a non-zero value using the remaining bLeft bits. This may be done, for example, according to process outlined in example pseudo code (E), presented below. In embodiments of the invention, frequency range tuning is not used in the additional encoding stage.

Example pseudo code (E)

```
1. Determine the number of frequency components to be accepted for
further quantization based on the number of available bits.
  If bLeft < 20
    nAllowedSamples = └bLeft·0.5┘
  Else
    nAllowedSamples = └bLeft·0.75┘
2. Find the frequency components to be quantized
  For(j = 0, newSamples = 0; j < M; j++)
  {
      If diff_{f} [fStartOffset + j]== 0 and newSamples < nAllowedSamples
      {
        inQ_Coef[newSamples] = diff_{f} [fStartOffset + j];
        Increase newSamples by 1
      }
  }
3. Quantize the frequency components from indices 0 to newSamples in
variable inQ_coef using bLeft bits
4. Determine and quantize quantizer gain
```

In step 1 of example pseudo code (E) a determination regarding the number of frequency components to be quantized is performed by frequency component selection unit 404 based on the number of bits available for the additional encoding stage. In case the variable bLeft indicates that less than 20 bits are available, the upper limit for the number of frequency components nAllowedSamples to be quantized is set to 0.5 times the number of available bits, while in case the number of available bits is larger than or equal to 20, the upper limit for the number of frequency components nAllowedSamples to be quantized is set to 0.75 times the number of available bits. In step 2, frequency component selection unit 404 selects a number of lowest frequency components of the presence signal diff_{f} for quantization in the additional encoding stage. The number of selected frequency components is indicated by variable newSamples, and the frequency components are held in variable inQ_Coef. In step 3, signal quantization unit 412 quantizes the frequency components selected in step 2 using at most a number of bits indicated by variable bLeft. In step 4, gain quantization unit 414 determines the quantizer gain for the additional encoding stage, for example according to equation (4) above and quantizes it. In an embodiment of the invention, seven bits are used to quantize the quantizer gain for the additional encoding stage.

In some embodiments, the additional encoding stage(s) may be activated only in the event that the number of remaining available bits bLeft indicated by bit allocation unit 408 meets a pre-determined condition. As an example, the additional encoding stage may be activated only in case the number of available bits is greater than a pre-determined threshold.

In embodiments of the invention in which one or more additional encoding stage is performed when remaining bits are available, the newly quantized frequency components are provided to data aggregation unit 416, for example as the variable inQ_Coe\hat{f}, for inclusion in the output bitstream of presence encoding unit 212. Gain quantization unit 414 provides the quantized quantizer gains to data aggregation unit 416 for inclusion in the output bitstream of presence encoding unit 212.

In the embodiment of the invention illustrated in FIG. 4, data aggregation unit 416 constructs an output bitstream representative of the presence signal determined in presence signal determination unit 401 using the various inputs provided to it by frequency range selection unit 402, frequency range tuning unit 406, bit allocation unit 408, signal quantization unit 412, and gain quantization unit 414. In embodiments that do not employ a frequency range tuning unit 406, or a bit allocation unit 408, the output bitstream is constructed without contributions from the omitted unit(s).

The output bitstream provided for each frame of the input signal may comprise a single encoded frame representative of the presence signal determined for the input frame in question. The output bitstream may be constructed, for example, according to the procedure described by example pseudo code (F) presented below:

Example pseudo code (F)

```
  1: Store fStart
  2: For(i = 0; i < N; i++)
  3: {
  4: Store nQ_Idx1 for stage i
  5: If nQ_Idx1 == 0
  6: Store nQ_Idx2 for stage i
  7: Store quantized frequency components for stage i
  8: If I == 0
  9: Store quantizer gain gIdxᵢ
10: Else
11: Store quantizer gain difference gIdxᵢ₋₁ − gIdxᵢ
12: }
13: Store quantized frequency components for the additional stage
14: Store gIdx for additional stage
```

Referring to line 1 of example pseudo code (F), the first data element included in the encoded frame is an indication of the selected frequency range, represented by the index fStart of the table of available frequency range candidates startOffsetTbl described above. The loop running from line 2 to line 12 considers one encoding stage at a time, using variable i to denote the number of the encoding stage. Frequency range tuning information is provided next (lines 4 to 6 of example pseudo code (F)). In the illustrated example, the value of the variable nQ_Idx1 is provided first, followed by the value of nQ_Idx2. As described above, nQ_Idx1 indicates the number of frequency components excluded from the encoding process at the higher frequency end of the frequency range for a particular encoding stage i. Correspondingly, nQ_Idx2 indicates the number of frequency components excluded from the encoding process at the lower frequency end of the selected frequency range at encoding stage i. Lines 4 to 6 of example pseudo code (F) are formulated such that frequency components may be excluded from the encoding process at any encoding stage i, either at the lower frequency end of the frequency range or at the higher frequency end of the selected frequency range, but not from both ends. The skilled person will appreciate that corresponding formulations may be derived for alternative embodiments in which other possibilities are provided for frequency range tuning. For example, in some embodiments, frequency components may be excluded from both the higher and the lower end of the selected frequency range at each encoding stage. Corresponding code may be written to allow components excluded at both ends of the selected frequency range to be indicated in the output bitstream. Similarly, corresponding code may be written for embodiments in which exclusion of frequency components at only the higher end or only the lower end of the selected frequency range is permitted.

Referring back to example pseudo code (F), the values of the quantized frequency components at encoding stage i (line 7 of the pseudo code) are the next elements to be included in the encoded frame, followed by quantized quantizer gain gIdx. Quantized quantizer gain gIdx is provided as an absolute value in the first encoding stage (lines 8 and 9 of example pseudo code (F)) and as a quantized difference between the quantizer gain value for encoding stage i and the quantizer gain value for encoding stage i-1 in the subsequent encoding stages (lines 10 & 11 of the pseudo code). On lines 13 and 14 of the pseudo code, after completion of the loop for encoding stages 1 to N, the quantized frequency components and the quantizer gain gIdx for any additional encoding stage(s) are provided.

In an example embodiment, the number of bits used to represent fStart is 3, the number of bits for nQ_Idx1 is 3 and the number of bits for nQ_Idx2 is 2. The quantized frequency components at each encoding stage are represented using B/N bits, the number of bits used to represent gIdx at the first encoding stage is 7, and the number of bits for gIdx at subsequent encoding stages is 4. The number of bits used for the quantized frequency components of the additional encoding stage is bLeft, and the number of bits for the gIdx of the additional encoding stage(s) is 7.

In other embodiments, frame aggregation unit 416 may generate several encoded components to represent a single frame of the input signal. This approach may be used, for example, to provide the output bitstream of the presence encoding unit with a layered structure. As an example, the frame aggregation unit may be configured to form one encoded component comprising the value of fStart and the values of all variables (nQ_Idx1, nQ_Idx2, quantized frequency components, and the quantized quantizer gain gIdx) for the first encoding stage. Another encoded component may comprise all the variable values from the second encoding stage, a third encoded component may be generated, comprising the variable values from the third encoding stage, and so on until variable values from all N stages are processed. A benefit of such an approach is that a receiver may be able to reconstruct a subset of frequency components even if only a subset of the encoded components corresponding to a frame of the input signal are available.

FIG. 5 illustrates a decoder 300 according to an embodiment of the present invention. In the example of FIG. 5, decoder 300 is configured to operate in co-operation with the encoder 200 illustrated in FIG. 2 to reconstruct a two-channel (stereo) audio signal from a received input bitstream. The input bistream may be received, for example, from a network interface (not shown) or from a stored file in a memory (not shown). In the embodiment of FIG. 5, the input bitstream comprises a series of single encoded components, each single encoded component being representative of a single frame of the input signal. As described in connection with FIG. 2, the single encoded components comprise an encoded downmix signal produced by the audio encoder unit 208 of encoder 200, an encoded presence signal from presence encoding unit 212, and encoded parametric information from parametric encoder 210 (if present).

Transport interface 302 of decoder 300 demultiplexes the single encoded component representative of a particular frame to recover the encoded downmix signal and the encoded presence signal for the frame in question, as well as the encoded parametric information, if present. Transport interface 302 provides the encoded downmix signal to audio decoder 304, and further provides the encoded presence signal to presence decoding unit 306. In an embodiment comprising a parametric decoder 312, encoded parametric information, if received, is provided to parametric decoder 312.

In some embodiments, the bitstream representative of an input frame received by transport interface 302 may comprise multiple encoded components per frame, possibly comprising a layered structure, as described above for the encoder. Also in this embodiment the respective encoded components are provided to audio decoder 304, presence decoding unit 306, and to parametric decoder 312, if present.

In embodiments that do not include a parametric decoder 312, decoder 300 may be configured to identify that parametric information relating to a presence signal is present in the received input bitstream and to discard the received parametric information. This may have the technical effect of enabling decoder 300 to operate in conjunction with a wider variety of corresponding encoder implementations.

In the embodiment of the invention illustrated in FIG. 5, audio decoder 304 reconstructs the downmix signal \tilde{M}_{f} based at least part on the received encoded downmix signal provided by transport interface 302. The reconstructed downmix signal \tilde{M}_{f} is provided to signal synthesis unit 314 for reconstruction of the signal. Presence decoding unit 306 reconstructs the presence signal di\tilde{f}\tilde{f}_{f} based at least part on the received encoded presence signal provided by transport interface 302. Signal synthesis unit 314 uses the reconstructed downmix signal \tilde{M}_{f} provided by audio decoder 304 and the reconstructed presence signal provided by presence decoding unit 306 to derive reconstructed frequency-domain left and right channel signals \tilde{L}_{f} and \tilde{R}_{f}, respectively. As an example, the frequency-domain left and right channel signals \tilde{L}_{f} and \tilde{R}_{f} signals may be derived using equation (6):

\tilde{L}_{f}(j)=\tilde{M}_{f}(j)+di\tilde{f}\tilde{f}_{f}(j)

\tilde{R}_{f}(j)=\tilde{M}_{f}(j)−di\tilde{f}\tilde{f}_{f}(j), 0≦j<M (6)

The reconstructed frequency-domain left and right channel signals \tilde{L}_{f} and \tilde{R}_{f} are transformed into corresponding time-domain signals \tilde{L} and \tilde{R} by inverse transform units 308 and 310, respectively. The transform technique used in inverse transform units 308 and 310 may be for example DFT, a combination of MDCT and MDST, QMF, or any other suitable inverse transform technique matching the transform technique used in the encoder. Alternatively, inverse transform units 308 and 310 may be combined as a single inverse transform unit performing the inverse transform for each of the reconstructed frequency-domain channels.

In embodiments that employ a parametric decoder 312, the parametric decoder reconstructs the audio channels based at least part on encoded parametric information received from transport interface 302. In some embodiments, the reconstructed downmix signal \tilde{M}_{f} provided by audio decoder 304 may be used in parametric decoder 312 to assist reconstruction of the audio signal. In case a reconstructed signal for a frequency component is received both from presence decoding unit 306 and from parametric decoder 312, signal synthesis unit 314 selects which of the signals to use to form the output channels \tilde{L}_{f} and \tilde{R}_{f}. In an example embodiment, the reconstructed presence signal provided by presence decoding unit 306 takes precedence. In another embodiment, equation (6) is applied only for frequency components that have a non-zero value in the reconstructed presence signal provided by presence decoding unit 306, and for the other frequency components the signals provided by the parametric decoder are used.

In another embodiment, in case a reconstructed signal for a frequency component is received both from presence decoding unit 306 and from parametric decoder 312, signal synthesis unit 314 may form the output channels \tilde{L}_{f} and \tilde{R}_{f} based on combination of signal received from presence decoding unit 306 and from parametric decoder 312.

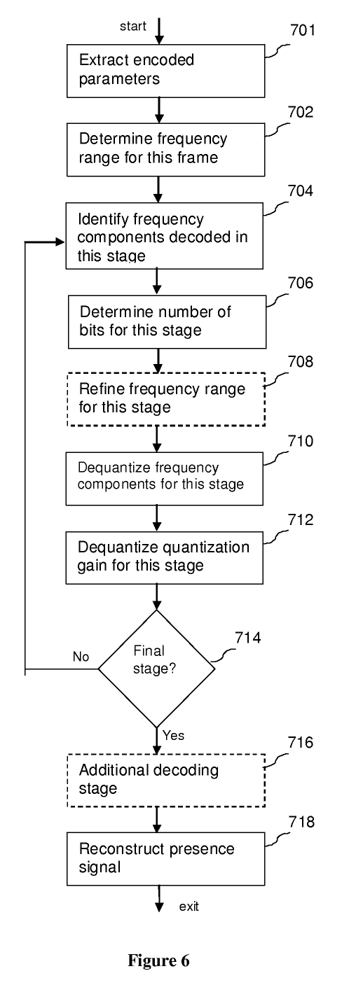

FIG. 6 presents a flowchart illustrating the operation of a presence decoding unit according to an embodiment of the invention. In the illustrated embodiment, an encoded presence signal for a frame of an encoded audio signal is decoded by applying an N-stage decoding process. The encoded presence signal may have been formed, for example, according to the N-stage encoding process described in connection with FIG. 3.

At step 701, quantized presence signal components for use in the N decoding stages are extracted from one or more received encoded component(s) representative of an audio frame. The extracted components may comprise, for example, information relating to the frequency range of the encoded presence signal, frequency range tuning information, bit allocation information, and/or quantized presence signal components generated in one or more additional encoding stage(s). In step 702, the frequency range of the encoded presence signal is determined, either by using predetermined information or based at least part on the received information. At step 704 the frequency components to be reconstructed in a current decoding stage are determined. In an embodiment of the invention, this is done by determining which frequency components within the determined frequency range have not been reconstructed to a non-zero value in an earlier decoding stage(s). In step 706, the number of bits allocated for the current decoding stage is determined. This determination may be based at least partially on received bit allocation information, or a predetermined bit allocation may be employed.

If frequency range tuning information is received, the determined frequency range of the encoded presence signal is refined at step 708. This may be done, for example, by excluding some of the frequency components from the lower frequency end of the frequency range and/or by excluding some of the frequency components from the higher frequency end of the frequency range, based at least part on received frequency range tuning information.

In step 710 the received frequency components covering the selected (and possibly refined) frequency range are dequantized, and the quantizer gain for the current decoding stage is dequantized at step 712. At step 714 a test is performed to determine whether the current decoding stage was the final decoding stage. In the case that the current stage was not the final decoding stage, the next decoding stage is started and the method continues from step 704. In the case that the current stage was the final decoding stage, the process exits the loop comprising method steps 704 to 714 and processing continues from step 716.

Step 716 represents an additional decoding stage that is performed in the event that the components extracted at step 701 comprise quantized presence signal components generated in one or more additional encoding stage(s). Step 716 comprises determining the number of bits used for the additional decoding stage, determining the frequency component(s) to be decoded in the additional decoding stage(s), dequantizing the quantized frequency component(s) and the corresponding quantized quantizer gain for the additional decoding stage. If the encoded presence signal comprises quantized presence signal components for more that one additional encoding stage, step 716 may be performed once for each additional stage.

Finally, in step 718, the reconstructed presence signal components from the N decoding stages, as well as the possible additional decoding stage(s), are determined by multiplying the dequantized frequency components obtained during the respective decoding stages by a value based at least part on the corresponding dequantized quantizer gain value for the stage. The reconstructed presence signal is determined by combining the reconstructed presence signal components from the individual decoding stages. This may be done by adding together the reconstructed presence signal components from each stage.

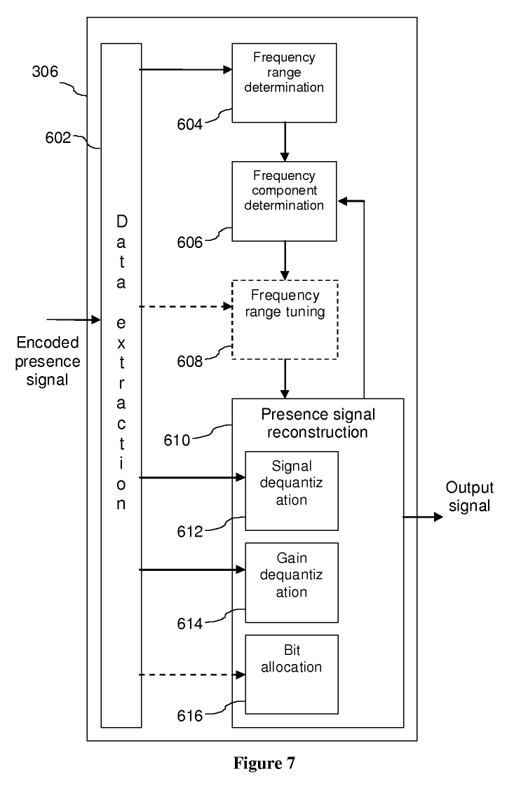

FIG. 7 illustrates a presence decoding unit 306 according to an embodiment of the invention. The presence decoding unit comprises a data extraction unit 602, a frequency range determination unit 604, a frequency component determination unit 606, a frequency range tuning unit 608, and a presence signal reconstruction unit 610. Presence signal reconstruction unit 610 comprises a signal dequantization unit 612, a gain dequantization unit 614, and a bit allocation unit 616. In alternative embodiments that do not use frequency range tuning, frequency range tuning unit 608 may be omitted.

Presence decoding unit 306 of FIG. 7 is configured to apply an N-stage decoding process to recover a presence signal encoded in accordance with the N-stage encoding process presented in connection with FIG. 4.

As described in connection with FIG. 4, the encoded presence signal may comprise information relating to the frequency range of the encoded presence signal and quantized presence signal components. The quantized presence signal components may comprise quantized frequency components, encoded in N stages, together with a corresponding quantized quantizer gain for each one of the N stages. The encoded presence signal may further comprise frequency range tuning information for each of the N stages, and/or bit allocation information. In some embodiments of the invention, the quantized signal components may further comprise quantized frequency components and a quantized quantizer gain for one or more additional encoding stage(s) performed in the encoder responsive to there being unused bits available after completion of the N encoding stages.

In the embodiment illustrated in FIG. 7, data extraction unit 602 receives the encoded presence signal, for example from transport interface 302 of FIG. 5. Data extraction unit 602 extracts the information relating to the frequency range of the encoded presence signal, and passes the extracted information on the frequency range to frequency range determination unit 604 for use in the corresponding decoding process.

Frequency range determination unit 604 determines the frequency range of the encoded presence signal at a particular encoding stage based at least part on the information provided by data extraction unit 602. In embodiments in which the frequency range comprises a predetermined number of spectral bins and is selected from among a predetermined number of available frequency range candidates, the frequency range of the encoded presence signal at a particular encoding stage may be indicated in the encoded bitstream as an index into a look-up table that indicates the starting frequencies of the available frequency range candidates (see the derivation of the fStart variable, as presented in connection with the description of presence encoding unit 212 in FIG. 4). In such an embodiment, frequency range determination unit 604 determines the frequency range of the encoded presence signal at the encoding stage in question by using the received index to look up the starting frequency of the range from a corresponding look up table that is stored, for example, in a memory that can be accessed by the decoder. Having determined the starting (e.g. lower) frequency of the frequency range, frequency range determination unit 604 may further determine the upper frequency of the range by adding the known frequency span of the spectral bins that make up the range to the determined lower frequency.

Frequency component determination unit 606 determines the signal components within the identified frequency range to be reconstructed in the current decoding stage, and provides this information to frequency range tuning unit 608.

If the received information relating to the frequency range of the encoded presence signal comprises frequency range tuning information for some or all of the N decoding stages, data extraction unit 602 provides this information to frequency range tuning unit 608 for use in the corresponding decoding stage. Frequency range tuning unit 608 accordingly adjusts the determination of which signal components are to be reconstructed at the decoding stage in question and provides a corresponding indication to presence signal reconstruction unit 610. At any given encoding stage, the frequency components may have been limited at the lower end of the frequency range determined by the frequency range determination unit 604 and/or at the higher end of the frequency range, as described in connection with presence encoding unit 212 of FIG. 4.

In decoder embodiments in which frequency range fine tuning is not performed, information concerning the signal components to be reconstructed at a current decoding stage may be provided to presence signal reconstruction unit 610 directly from frequency component determination unit 606.

At a given decoding stage, data extraction unit 602 extracts the quantized presence signal components to be reconstructed and provides them to presence signal reconstruction unit 610. In embodiments in which the quantized presence signal components comprise quantized frequency components and a corresponding quantized quantizer gain for each stage, data extraction unit 602 provides the quantized frequency components to signal dequantization unit 612 and further provides the corresponding quantized quantizer gain for each stage to gain dequantization unit 614. Signal dequantization unit 612 is configured to dequantize the quantized frequency components representative of the presence signal. Gain dequantization unit 614 is configured to dequantize the corresponding quantized quantizer gain values provided for a given stage.

If the encoded presence signal comprises quantized frequency components and a corresponding quantized quantizer gain for one or more additional encoding stage(s) performed by the encoder, data extraction unit 602 provides them to signal dequantization unit 612 and gain dequantization unit 614, respectively.

In embodiments where bit allocation information is provided to indicate the number of bits assigned to the various encoded parameters, data extraction unit 602 extracts the bit allocation information and provides this information to bit allocation unit 616 of presence signal reconstruction unit 610. In some embodiments, in which bit allocation information is not provided, for example because a predetermined bit allocation scheme is used for parameter quantization, bit allocation unit 616 may use predetermined information on the bit allocation for each of the decoding stages.

In embodiments of the invention, data extraction unit 602 may be configured to extract the quantized presence signal components for all N stages at once. Data extraction unit 602 may then provide signal dequantization unit 612 with the quantized presence signal components for dequantization at a particular decoding stage at the beginning of the decoding stage in question. Similarly, data extraction unit 602 may be configured to extract the quantized quantizer gain values for all N stages at once and to provide gain dequantization unit 614 with the quantized quantizer gain corresponding to a particular decoding stage at the beginning of the decoding stage in question. In other embodiments, data extraction unit 602 may be configured to work iteratively, extracting the quantized presence signal components and the quantized quantizer gain value for a given decoding stage during the decoding stage itself.

At any given decoding stage, signal dequantization unit 612 dequantizes the quantized frequency components for the stage in question. In a similar manner, gain dequantization unit 614 dequantizes the quantizer gain value for the decoding stage in question. Presence signal reconstruction unit 610 determines reconstructed signal components for the stage in question, by applying the dequantized quantizer gain to the dequantized frequency components, for example by multiplying each dequantized frequency component for the stage by the corresponding dequantized quantizer gain. Presence signal reconstruction unit 610 determines the reconstructed presence signal by combining the reconstructed signal components obtained at each of the N decoding stages. The reconstructed presence signal forms the output of presence decoding unit 306.

In embodiments in which presence signal reconstruction unit 610 receives quantized frequency components and a quantized quantizer gain value corresponding to one or more additional encoding stage(s) performed by the encoder, signal dequanization unit 612 dequantizes the quantized frequency components for the one or more additional stage(s), and gain dequantization unit 614 dequantizes the corresponding quantized quantizer gain(s) for the additional stage(s). Presence signal reconstruction unit 610 is further configured to determine a reconstructed signal component for the one or more additional decoding stage(s) by applying the respective dequantized gain to the respective dequantized frequency components for the stage(s), for example by multiplying each dequantized frequency component for the additional stage(s) by the corresponding dequantized quantizer gain value. Presence signal reconstruction unit 610 further combines the reconstructed signal component in the additional decoding stage(s) with the reconstructed presence signal determined based on the N decoding stages to form the reconstructed presence signal.

Example pseudo code (G), shown below, presents an example of the presence signal decoding process according to an embodiment of the invention. In the illustrated example, the encoded presence signal comprises information on the frequency range of the encoded presence signal, frequency range tuning information for each of the N decoding stages, and quantized presence signal components. The quantized presence signal components comprise quantized frequency components for N decoding stages and a respective quantized quantizer gain value for each of the N decoding stages.

Example pseudo code (G)

```
  1: initialize buffer [symbol]  as zeros
  2: extract fStart
  3: For(i = 0; i < N; i++)
  4: {
  5: nQ_Idx2 = 0
  6: extract nQ_Idx1
  7: If nQ_Idx1 == 0
  8: extract nQ_Idx2
9: nBins = 0;
10: For(j = 0; j < M; j++)
11: If [symbol]  [fStartOffset + j] == 0
12: Increase nBins by 1
13: nBins = nBins − nQ_Idx1 * T_inc1
14: jOffset = nQ_Idx2 * T_inc2
15: Set temporary buffer qC₂ of size M to zero values
16: Read quantized components of length nBins - jOffset, into qC₂
17: extract gIdxᵢ
18: If I > 0
19: gIdxᵢ = gIdxᵢ₋₁ − gIdxᵢ
21: nBins = 0;
22: For(j = 0; j < M; j++)
23: {
24: If [symbol]  [fStartOffset + jOffset + j] == 0
25: [symbol]   [fStartOffset + jOffset + j] = 10^{gIdx}^{ᵢ}^{/24} * qC₂ [nBins]
26: Increase nBins by 1
27: }
28: }
```

On line 1 of example pseudo code (F) variable di\tilde{f}\tilde{f}_{f} is initialized to zero. di\tilde{f}\tilde{f}_{f} represents a buffer in which the reconstructed presence signal components will be stored. On line 2, information relating to the frequency range of the encoded presence signal in a current frame is extracted by data extraction unit 602. In the illustrated embodiment, the information about the frequency range of the encoded presence signal takes the form of a variable fStart representing the starting frequency of the frequency range selected for the current frame during encoding. Given fStart, frequency range determination unit 604 determines the frequency range of the encoded presence signal by finding the starting point of the selected frequency range as described in equation (3), thus setting the value of variable fStartOffset.

Next, the loop running from line 3 to line 28 is executed for each decoding stage, the index i indicating the number of current decoding stage. On lines 5-8, the variables nQ_Idx2 and nQ_Idx1 descriptive of the frequency range tuning information for decoding stage i are extracted by data extraction unit 602. On lines 9-12, frequency component determination unit 606 determines the components to be dequantized in decoding stage i by identifying dequantized components within the selected frequency range that currently have a value of zero. The number of zero-valued components is recorded in variable nBins. On lines 13-14, frequency range tuning unit 608 limits the frequency components processed at the current decoding stage in accordance with the frequency range tuning information provided by variables nQ_Idx2 and nQ_Idx1. In the illustrated embodiment, frequency range tuning may be applied to limit the frequency components taken into consideration in decoding stage i either at the higher frequency end of the frequency range (line 13) or at the lower frequency end of the frequency range (line 14).

Next, presence signal reconstruction unit 610 initializes a temporary buffer qC₂ to zero. Data extraction unit 602 extracts quantized frequency components for decoding stage i, covering the adjusted frequency range determined by frequency range tuning unit 608. Signal dequantization unit 612 dequantizes the quantized frequency components for decoding stage i and stores the dequantized frequency components in the temporary buffer qC₂.

On lines 17-19 data extraction unit 602 extracts the quantized quantizer gain for decoding stage i and stores the quantized gain value in variable gIdxᵢ. In the illustrated embodiment, the quantized quantizer gain values for encoding stages subsequent to the first stage are represented as difference values with respect to the quantized quantizer gain value at the immediately preceding stage. Hence corresponding reconstruction of the quantized quantizer gain value is performed during decoding (line 19).

Finally, the presence signal is reconstructed on lines 21-27. In more detail, at line 25 gain dequantization unit 614 dequantizes the quantized quantizer gain value for the current decoding stage. In the illustrated embodiment, logarithmic quantization of the quantizer gain value with logarithms to base 10 is used and so gain dequantization unit 614 performs a corresponding inverse logarithmic operation, raising 10 to the power (gIdx/24) to generate a dequantized quantizer gain value. Also at line 25, presence signal reconstruction unit 610 multiplies the frequency components dequantized in current decoding stage i (held in variable qC₂) with the dequantized quantizer gain determined by the gain dequantization unit to reconstruct the presence signal components for decoding stage i. The reconstructed presence signal components for stage i are stored in buffer variable di\tilde{f}\tilde{f}_{f}.

If the encoded presence signal comprises quantized presence signal components corresponding to one or more additional encoding stages performed at the encoder, bit allocation unit 616 determines the number of bits bLeft used for quantization of the presence signal components in the additional stage(s). An indication of the number of bits used in the additional stage(s) may be received as part of the bit allocation information for the encoded presence signal, or it may be determined based on knowledge of the overall number of bits available and the number of bits used for quantizing the presence signal components in the N encoding stages. Frequency component determination unit 606 provides an indication of the frequency components that were not dequantized to a non-zero value during the N encoding stages, and presence signal reconstruction unit 610 employs signal dequantization unit 612 and gain dequantization unit 614 to dequantize the received quantized frequency components and received quantized quantizer gain, respectively. Presence signal reconstruction unit 610 multiplies the frequency components dequantized in the one or more additional decoding stage(s) with their respective dequantized quantizer gain(s) to determine the reconstructed presence signal components in the additional decoding stage(s). In an embodiment, the process presented below as example pseudo code (H) may be used in an additional decoding stage to dequantize additional frequency components of the presence signal together with their associated quantizer gain:

Example pseudo code (H)

```
1. Determine the number of additional frequency components to be
dequantized
  If bLeft < 20
    nAllowedSamples = └bLeft·0.5┘
  Else
    nAllowedSamples = └bLeft·0.75┘
2. Read and dequantize quantized frequency components of length
nAllowedSamples, place the result to qDec
3. Read and dequantize the quantizer gain qIdx (7 bits)
4. Decode the result
  For(j = 0, newSamples = 0; j < M; j++)
  {
      If [symbol]  [fStartOffset + j]== 0 and newSamples < nAllowedSamples
      { [symbol]
        [fStartOffset + j]= 10^{gIdx/24} * qDec[newSamples];
        Increase newSamples by 1
      }
  }
```

In step 1 of example pseudo code (H) a determination regarding the number of frequency components quantized in the additional encoding stage is performed by frequency component determination unit 606 based on the number of bits bLeft that have been available for the additional encoding stage. In case the variable bLeft indicates that less than 20 bits have been available, the upper limit for the number of frequency components nAllowedSamples quantized in additional encoding stage is set to 0.5 times the number of available bits, while in case the number of available bits has been larger than or equal to 20, the upper limit for the number of frequency components nAllowedSamples quantized is set to 0.75 times the number of available bits by frequency component determination unit 606. In step 2, the quantized components are provided by data extraction unit 602, dequantized by signal dequantization unit 612, and placed in variable qDec by presence signal reconstruction unit 610. In step 3 the quantized quantizer gain provided by data extraction unit 602 is dequantized by gain dequantization unit 614 and placed in variable qIdx by presence signal reconstruction unit 610. In step 4, the frequency components encoded in additional encoding stage are decoded and stored to variable di\tilde{f}\tilde{f}_{f} by presence signal reconstruction unit 610. Without in any way limiting the scope, interpretation, or application of the claims appearing below, it is possible that a technical effect of one or more of the example embodiments disclosed herein may be improved coding of audio signals at low bit-rates. Another possible technical effect of one or more of the example embodiments disclosed herein may be improved flexibility of the decoding process. Another technical effect of one or more of the example embodiments disclosed herein may be a more efficient encoding of presence information associated with an audio signal and/or a more accurate encoded representation of the presence information compared with that obtained by prior art methods at the same encoding bit-rate.

Embodiments of the present invention may be implemented in software, hardware, application logic or a combination of software, hardware and application logic. The software, application logic and/or hardware may reside on any form of communication apparatus, such as mobile phone, landline phone, a desktop computer, a laptop computer, etc. The software application logic and/or hardware may also reside on a network element of a communication system, such as a gateway, a transcoder apparatus, a server apparatus, a conference bridge, etc. The communication apparatus and/or a network element may be suitable for a telephony application, audio/video conferencing, an audio/video streaming service, a broadcasting service, etc. Furthermore, the software application logic and/or hardware may also reside on any form of music recording, transcoding or reproduction apparatus. The music recording, transcoding or reproduction apparatus may be suitable for professional applications, for example as used in music, television or film recording studios, or in connection with music distribution via recorded media such as compact discs, tape recordings or solid state memory devices and/or the like. Alternatively or additionally, embodiments of the present invention may be used in connection with music distribution via the Internet, for example music download services. An example of a music download service in which an encoding method according to an embodiment of the invention may be applied, is the downloading of pre-recorded music tracks over the Internet or via a mobile communication network such as that provided by a mobile telephone operator. Furthermore, the music recording, transcoding or reproduction apparatus may be provided in connection with consumer electronic products, such as portable music players, home hi-fi systems and/or surround sound systems, computers, wireless communication devices such as mobile telephones and/or the like. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus for encoding an audio signal in two or more encoding stages, the audio signal comprising a set of frequency components, the apparatus comprising:
a frequency component selection unit configured to select a number of frequency components from said set for encoding in a current encoding stage, the selected frequency components being components of said set that have not been encoded to a non-zero value in a preceding encoding stage, and
an encoding unit configured to encode at least one of the selected frequency components to a non-zero value using a number of bits less than or equal to a predetermined number of bits allocated for the current encoding stage.

2-97. (canceled)

98. An apparatus according to claim 1, further comprising a frequency range tuning unit configured to limit the number of frequency components selected from said set in the current encoding stage by excluding from consideration a number of lowest frequency components and/or a number of highest frequency components within the set.

99. An apparatus according to claim 1, further comprising a signal forming unit configured to form the audio signal to be encoded to comprise at least one difference signal derived based at least in part on two or more audio channels.

100. An apparatus according to claim 99, wherein the signal forming unit is further configured to form the audio signal to be encoded to comprise a subset of frequency components of said two or more audio channels.

101. An apparatus according to claim 1, comprising a bit allocation unit configured to determine the number of bits available for an encoding stage by distributing the total number of available bits evenly across a pre-determined number of encoding stages.

102. An apparatus according to claim 101, further configured to perform at least one additional encoding stage when a number of unused bits available after encoding using said pre-determined number of encoding stages exceeds a pre-determined threshold.

103. An apparatus according to claim 1, further comprising a quantization unit configured to quantize amplitude values of the frequency components selected at a particular encoding stage and/or to quantize a gain value associated with the frequency components selected at said particular encoding stage.

104. An apparatus for decoding an encoded audio signal in two or more decoding stages, the audio signal comprising a set of frequency components, the apparatus comprising:
a frequency component selection unit configured to select a number of frequency components of said set to be decoded in a current decoding stage, the selected frequency components being components of said set that have not been reconstructed to a non-zero value in a preceding decoding stage,
a decoding unit configured to decode the frequency components selected in the current decoding stage and to reconstruct a component of the audio signal based at least in part on the frequency components decoded in the current decoding stage.

105. An apparatus according to claim 104, wherein the apparatus is configured to receive an indication of the frequency components the encoded audio signal represents.

106. An apparatus according to claim 104, wherein the apparatus further comprises a frequency range tuning unit configured to receive an indication to limit the number of frequency components to be decoded in the current decoding stage by excluding from consideration a number of lowest frequency components and/or a number of highest frequency components within the set.

107. An apparatus according to claim 104, wherein the decoding unit comprises a signal dequantization unit configured to apply a predetermined dequantization scheme to a predetermined number of bits representative of the frequency components to be decoded in the current decoding stage to obtain corresponding dequantized frequency component amplitude values.

108. An apparatus according to claim 107, wherein the decoding unit comprises a gain dequantization unit configured to apply a predetermined dequantization scheme to a predetermined number of bits representative of a gain value associated with the current decoding stage to obtain a corresponding dequantized gain value.

109. An apparatus according to claim 104, wherein the decoding unit is configured to reconstruct the audio signal by multiplying the dequantized frequency component amplitude values obtained at each decoding stage with the corresponding gain value associated with the respective decoding stage to obtain weighted frequency component amplitude values for each decoding stage and combining the weighted frequency component amplitudes thus obtained.

110. A method for encoding an audio signal in two or more encoding stages, the audio signal comprising a set of frequency components, the method comprising:
selecting a number of frequency components from said set for encoding in a current encoding stage, the selected frequency components being components of said set that have not been encoded to a non-zero value in a preceding encoding stage, and
encoding at least one of the selected frequency components to a non-zero value using a number of bits less than or equal to a predetermined number of bits allocated for the current encoding stage.

111. A method according to claim 110, further comprising limiting the number of frequency components selected from said set in the current encoding stage by excluding from consideration a number of lowest frequency components and/or a number of highest frequency components within the set.

112. A method according to claim 110, comprising forming the audio signal to be encoded to comprise at least one difference signal derived based at least in part on two or more audio channels.

113. A method according to claim 112, comprising forming the audio signal to be encoded to comprise a subset of frequency components of said two or more audio channels.

114. A method according to claim 110, comprising determining the number of bits available for an encoding stage by distributing the total number of available bits evenly across a pre-determined number of stages.

115. A method according to claim 110 comprising performing at least one additional encoding stage when a number of unused bits available after encoding using said pre-determined number of encoding stages exceeds a pre-determined threshold.

116. A method according to claim 110, comprising quantizing amplitude values of the frequency components selected at a particular encoding stage and/or quantizing a gain value associated with the frequency components selected at said particular encoding stage.

117. A method for decoding an encoded audio signal in two or more decoding stages, the audio signal comprising a set of frequency components, the method comprising:
selecting a number of frequency components of said set to be decoded in a current decoding stage, the selected frequency components being components of said set that have not been reconstructed to a non-zero value in a preceding decoding stage;
decoding the frequency components selected in the current decoding stage; and reconstructing a component of the audio signal based at least part on the frequency components decoded in the current decoding stage.

118. A method according to claim 117, comprising receiving an indication of the frequency components the encoded audio signal represents.

119. A method according to claim 117, comprising receiving an indication to limit the number of frequency components to be decoded in the current decoding stage by excluding from consideration a number of lowest frequency components and/or a number of highest frequency components within the set.

120. A computer program product for encoding an audio signal in two or more encoding stages, the audio signal comprising a set of frequency components, comprising a computer-readable medium bearing computer program code embodied therein for use with a computer, the computer program comprising:
code for selecting a number of frequency components from said set for encoding in a current encoding stage, the selected frequency components being components of said set that have not been encoded to a non-zero value in a preceding encoding stage, and
code for encoding at least one of the selected frequency components to a non-zero value using a number of bits less than or equal to a predetermined number of bits allocated for the current encoding stage.

121. A computer program product according to claim 120, further comprising code for limiting the number of frequency components selected from said set in the current encoding stage by excluding from consideration a number of lowest frequency components and/or a number of highest frequency components within the set.

122. A computer program product according to claim 120, comprising code for forming the audio signal to be encoded to comprise at least one difference signal derived based at least in part on two or more audio channels.

123. A computer program product according to claim 122, comprising code for forming the audio signal to be encoded to comprise a subset of frequency components of said two or more audio channels.

124. A computer program product according to claim 120, comprising code for determining the number of bits available for an encoding stage by distributing the total number of available bits evenly across a pre-determined number of stages.

125. A computer program product according to claim 124, comprising code for performing an additional encoding stage when a number of unused bits available after encoding using said pre-determined number of encoding stages exceeds a pre-determined threshold.

126. A computer program according to claim 122, comprising code for quantizing amplitude values of the frequency components selected at a particular encoding stage and/or code for quantizing a gain value associated with the frequency components selected at said particular encoding stage.

127. A computer program for decoding an encoded audio signal in two or more decoding stages, the audio signal comprising a set of frequency components, the computer program comprising:
code for selecting a number of frequency components of said set to be decoded in a current decoding stage, the selected frequency components being components of said set that have not been reconstructed to a non-zero value in a preceding decoding stage,
code for decoding the frequency components selected in the current decoding stage; and
code for reconstructing a component of the audio signal based at least part on the frequency components decoded in the current decoding stage.

128. A computer program according to claim 127, comprising code for receiving an indication of the frequency components the encoded audio signal represents.

129. A computer program according to claim 127, comprising code for receiving an indication to limit the number of frequency components to be decoded in the current decoding stage by excluding from consideration a number of lowest frequency components and/or a number of highest frequency components within the set.

130. A computer program according to claim 127, comprising code for applying a predetermined dequantization scheme to a predetermined number of bits representative of the frequency components to be decoded in the current decoding stage to obtain corresponding dequantized frequency component amplitude values.

131. A computer program according to claim 130, comprising code for applying a predetermined dequantization scheme to a predetermined number of bits representative of a gain value associated with the current decoding stage to obtain a corresponding dequantized gain value.

132. A computer program according to claim 127, comprising code for reconstructing the audio signal by multiplying the dequantized frequency component amplitude values obtained at each decoding stage with the corresponding gain value associated with the respective decoding stage to obtain weighted frequency component amplitude values for each decoding stage and code for combining the weighted frequency component amplitudes thus obtained.
